(19) United States
(12) Patent Application Publication
(10) Pub. No.: US 2025/0347390 A1
(43) Pub. Date: Nov. 13, 2025

(54) INTERNET OF THINGS (IOT) LARGE MODEL SYSTEM AND METHOD FOR LIFELINE ENGINEERING EMERGENCY SUPERVISION IN SMART CITIES

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/276,110

(22) Filed: Jul. 22, 2025

(30) Foreign Application Priority Data
Jul. 2, 2025 (CN) 202510906970.6

(51) Int. Cl. F17D 5/02; G06Q 50/26

(52) U.S. Cl. CPC F17D 5/02; G06Q 50/265

(57) ABSTRACT

An Internet of Things (IoT) large model system and a method for lifeline engineering emergency supervision in smart cities are provided. The method includes: in response to a gas environmental characteristic corresponding to a target pipeline satisfying a warning condition, every preset period: determining a target sensor based on spatial connectivity information corresponding to the target pipeline, and obtaining air flow data corresponding to the target sensor; obtaining a regional soil characteristic corresponding to the target pipeline; determining an estimated diffusion amplitude of a target gas based on gas transportation data of the target pipeline, the spatial connectivity information, the air flow data, and the regional soil characteristic; determining an inspection frequency and a sampling frequency based on the estimated diffusion amplitude, sending to an emergency supervision object platform, and obtaining a soil sample during inspection; and receiving a leakage warning when the soil sample is in an abnormal state.

### CROSS-REFERENCE TO RELATED APPLICATIONS

This application claims priority to Chinese Patent Application No. 202510906970.6, filed on Jul. 2, 2025, the contents of which are hereby incorporated by reference to its entirety.

### TECHNICAL FIELD

The present disclosure relates to the field of emergency supervision technologies, and particularly to an Internet of Things (IoT) large model system and a method for lifeline engineering emergency supervision in smart cities.

### BACKGROUND

In urban lifeline engineering, the management of various pipelines, including gas pipelines, is a key link. As many pipelines are laid in underground spaces, toxic, harmful, flammable, or explosive gases contained within the pipelines, such as natural gas, hydrogen sulfide, coal gas, chlorine, etc., can diffuse through minor leaks into surrounding underground pipe trenches, or even permeate into the soil environment, creating safety hazards such as threats to residents' health or serious safety accidents. Current robot inspections primarily focus on pipeline leakage detection, but gas monitoring in soil or pipe trenches is relatively neglected. Thus, it needs to solve a problem about how to assess the gas diffusion amplitude of different pipelines and the surrounding soil, to achieve targeted prevention and control for different regions.

Therefore, it is necessary to provide an Internet of Things (IoT) large model system and a method for lifeline engineering emergency supervision in smart cities, which can dynamically adjust working parameters of inspection robots in real-time based on an actual situation of gas diffusion around pipelines, to achieve precise discrimination and timely warning of leakage risks and realize effective emergency supervision.

### SUMMARY

The present disclosure provides a method for lifeline engineering emergency supervision in smart cities. The method includes: in response to a gas environmental characteristic corresponding to a target pipeline satisfying a warning condition, every preset period: determining a target sensor based on spatial connectivity information corresponding to the target pipeline, and obtaining air flow data corresponding to the target sensor; obtaining a regional soil characteristic corresponding to the target pipeline; determining an estimated diffusion amplitude of a target gas based on gas transportation data of the target pipeline, the spatial connectivity information, the air flow data, and the regional soil characteristic; determining an inspection frequency and a sampling frequency based on the estimated diffusion amplitude, and sending the inspection frequency and the sampling frequency to an emergency supervision object platform, to control an inspection robot to perform inspection based on the inspection frequency and obtain a soil sample based on the sampling frequency during inspection; and receiving a leakage warning sent by the inspection robot when the soil sample is in an abnormal state.

The present disclosure also provides an Internet of Things (IoT) large model system for lifeline engineering emergency supervision in smart cities. The IoT large model system includes an emergency supervision user platform, an emergency supervision service platform, an emergency supervision management platform, an emergency supervision sensor network platform, and an emergency supervision object platform; wherein the emergency supervision management platform is configured to execute the method for lifeline engineering emergency supervision in smart cities.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary platform structure of an Internet of Things (IoT) large model system for lifeline engineering emergency supervision in smart cities according to some embodiments of the present disclosure;

FIG. 2 is a flowchart illustrating an exemplary process of a method for lifeline engineering emergency supervision in smart cities according to some embodiments of the present disclosure;

FIG. 3 is a schematic diagram illustrating an exemplary process for determining a first diffusion amplitude according to some embodiments of the present disclosure;

FIG. 4 is a flowchart illustrating an exemplary process for determining an estimated diffusion amplitude according to some embodiments of the present disclosure; and

FIG. 5 is a schematic diagram illustrating an exemplary process for determining a second diffusion amplitude according to some embodiments of the present disclosure.

### DETAILED DESCRIPTION

The accompanying drawings, which are required to be used in the description of the embodiments, are briefly described below. The accompanying drawings do not represent the entirety of the embodiments.

When describing operations performed step-by-step in the embodiments of the present disclosure, unless otherwise specified, the order of the operations may be adjusted, some operations may be omitted, and additional operations may be included in the processes.

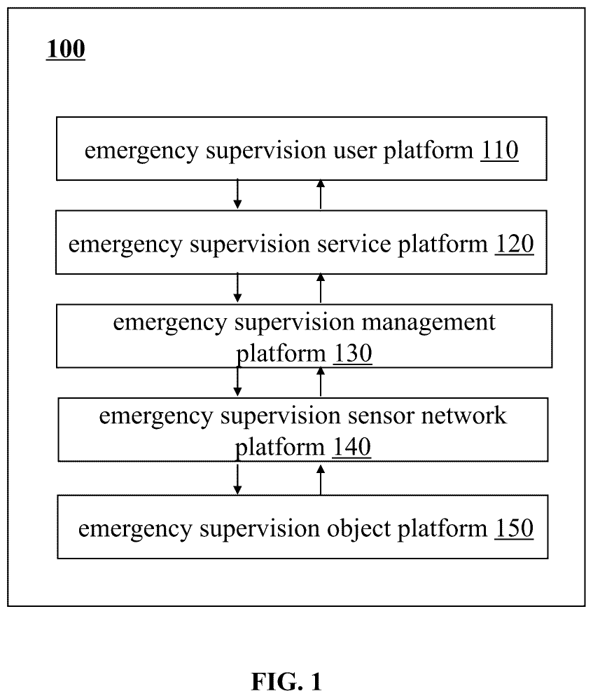

FIG. 1 is a schematic diagram illustrating an exemplary platform structure of an Internet of Things (IoT) large model system for lifeline engineering emergency supervision in smart cities according to some embodiments of the present disclosure.

In some embodiments, as shown in FIG. 1, an Internet of Things (IoT) large model system 100 for lifeline engineering emergency supervision in smart cities may include an emergency supervision user platform 110, an emergency supervision service platform 120, an emergency supervision management platform 130, an emergency supervision sensor network platform 140, and an emergency supervision object platform 150.

The emergency supervision user platform refers to a platform for initiating emergency supervision demands and receiving emergency supervision feedback information, which may be configured as a user terminal. For example, the emergency supervision user platform may be a device with input and/or output functions such as a computer.

The emergency supervision service platform refers to an interactive service platform for receiving and transmitting data, which may include communication terminals, such as wireless phones, video monitors, multimedia computers, etc.

In some embodiments, the emergency supervision service platform 120 interacts upward with the emergency supervision user platform 110 and downward with the emergency supervision management platform 130.

The emergency supervision management platform refers to a comprehensive platform for processing and managing emergency supervision data, which may include processors, storage devices, etc.

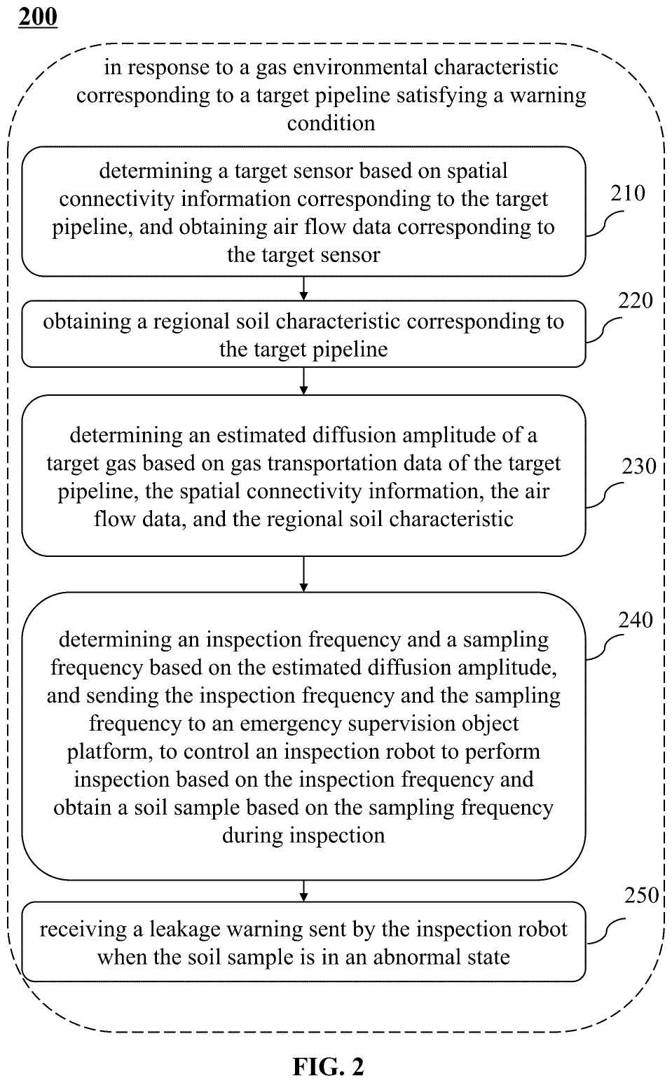

In some embodiments, the emergency supervision management platform 130 is configured to execute the method for lifeline engineering emergency supervision in smart cities. More details about the method may be found in FIGS. 2-5 and the relevant descriptions.

The emergency supervision sensor network platform refers to a management platform for transmitting emergency supervision-related sensing data or information, which may include communication networks or gateways, network interfaces, etc.

In some embodiments, the emergency supervision sensor network platform 140 may interact upward with the emergency supervision management platform 130 and downward with the emergency supervision object platform 150.

The emergency supervision object platform 150 refers to a platform for emergency supervision data acquisition and implementing execution instructions, including an inspection robot, etc. In some embodiments, the inspection robot within the emergency supervision object platform 150 is configured to perform inspection based on an inspection frequency, obtain a soil sample based on a sampling frequency during inspection, and send a leakage warning to the emergency supervision management platform when the soil sample is in an abnormal state.

More details about the aforementioned platforms may be found in FIGS. 2-5 and related descriptions.

In some embodiments of the present disclosure, the Internet of Things (IoT) large model system for lifeline engineering emergency supervision in smart cities can form an information operation closed loop between various functional platforms and operate coordinately and regularly under the unified management of the emergency supervision management platform. By dynamically adjusting the inspection frequency and sampling frequency of inspection robots efficiently and accurately, the processing efficiency for emergency scenarios is improved.

FIG. 2 is a flowchart illustrating an exemplary process of a method for lifeline engineering emergency supervision in smart cities according to some embodiments of the present disclosure. In some embodiments, a process 200 may be executed by the emergency supervision management platform 130.

In some embodiments, as shown in FIG. 2, in response to a gas environmental characteristic corresponding to a target pipeline satisfying a warning condition, the emergency supervision management platform executes the following operations 210-250 every preset period. The target pipeline refers to a pipeline that requires gas leakage monitoring.

The gas environmental characteristic refers to a characteristic related to a gas in a target region where the target pipeline is located, such as a concentration of a target gas in the soil of the target region, an air flow speed in the target region, etc. The target region refers to a region within a first preset range around the target pipeline. The first preset range may be preset by humans based on experience.

In some embodiments, the gas environmental characteristic corresponding to the target pipeline may be monitored by the inspection robot and uploaded to the emergency supervision management platform in real time.

The target gas refers to gas currently being transported in the target pipeline, which may be represented by a main component of the gas. For example, if the target pipeline transports natural gas, the corresponding target gas is methane.

The warning condition refers to a condition for initiating emergency inspection. The warning condition may be that the concentration of the target gas in the soil of the target region is greater than a first concentration threshold corresponding to the target gas, and/or the air flow speed exceeds a reference flow speed range corresponding to the target gas. The gas environmental characteristic corresponding to the target pipeline satisfying the warning condition indicates a high probability of a gas leakage problem, requiring the control of the inspection robot to perform enhanced inspection to further determine a location of the gas leakage.

In some embodiments, the first concentration threshold and the reference flow speed range corresponding to the target gas may both be preset by humans.

In some embodiments, the preset period may be set by humans based on historical experience or historical data. For example, the preset period may be 5 min, 10 min, etc.

In 210, determining a target sensor based on spatial connectivity information corresponding to the target pipeline, and obtaining air flow data corresponding to the target sensor.

The spatial connectivity information refers to information related to the spatial connectivity of the target pipeline within the target region. For example, a connectivity relationship between the target pipeline and structures such as underground utility tunnels, pipe trenches, and manholes within the target region, including connectivity directions and coordinates of connected locations, etc.

In some embodiments, the emergency supervision management platform may obtain the spatial connectivity information corresponding to the target pipeline based on pre-stored underground pipeline as-built drawings.

In some embodiments, the emergency supervision management platform may determine sensors deployed in the underground utility tunnels, the pipe trenches, the manholes, etc., within the target region as the target sensors. Types of target sensors include thermal anemometers, impeller anemometers, etc.

The air flow data corresponding to the target sensor includes the air flow speed and air flow direction collected by the target sensor.

In 220, obtaining a regional soil characteristic corresponding to the target pipeline.

The regional soil characteristic includes soil characteristics of a plurality of points in the target region. The soil characteristics include soil density, soil porosity, soil moisture content, etc.

In some embodiments, for a point, the emergency supervision management platform may determine a mean value of soil characteristics obtained from the latest M historical soil samplings at that point as the soil characteristic of that point. A sequence composed of the soil characteristics of the plurality of points in the target region is the regional soil characteristic. The latest M historical soil samplings refer to M historical soil samplings closest to a current time. M may be selected by humans based on actual situations. For example, M may be 3, 5, etc.

The inspection robot is equipped with a sampling device (such as a robotic arm) and a plurality of types of sensors (e.g., a soil moisture sensor, a density sensor, etc.) to perform soil sampling and analyze to obtain the soil characteristic and upload it to the emergency supervision management platform.

In some embodiments, the emergency supervision management platform may uniformly divide the target region to obtain the plurality of points. For example, dividing the target region into a plurality of sub-regions of equal area, with a center point of each sub-region being a point.

In 230, determining an estimated diffusion amplitude of a target gas based on gas transportation data of the target pipeline, the spatial connectivity information, the air flow data, and the regional soil characteristic.

The gas transportation data may include a type, a flow rate, a transportation pressure, etc., of the target gas transported by the target pipeline, which may be detected and acquired by the sensors (e.g., composition detectors, flow meters, pressure sensors, etc.) deployed in the target pipeline.

The estimated diffusion amplitude may include an estimated diffusion range, an estimated diffusion speed, an estimated diffusion volume, etc., of the target gas.

A diffusion range may be represented by an area of a region covered by the diffusion of the target gas. The diffusion speed may be represented by an area diffused per unit time. The diffusion volume may be represented by a leakage volume of the target gas.

In some embodiments, the emergency supervision management platform may determine the estimated diffusion amplitude by querying a first preset table based on the gas transportation data, the spatial connectivity information, the air flow data, and the regional soil characteristic.

The first preset table includes the correspondence between the gas transportation data, the spatial connectivity information, the air flow data, the regional soil characteristic, and the estimated diffusion amplitude. The first preset table may be constructed by humans based on historical data. For example, the first preset table is constructed using historical gas transportation data, historical spatial connectivity information, historical air flow data, and historical regional soil characteristics recorded during a plurality of historical monitoring, along with their corresponding historical actual diffusion amplitudes.

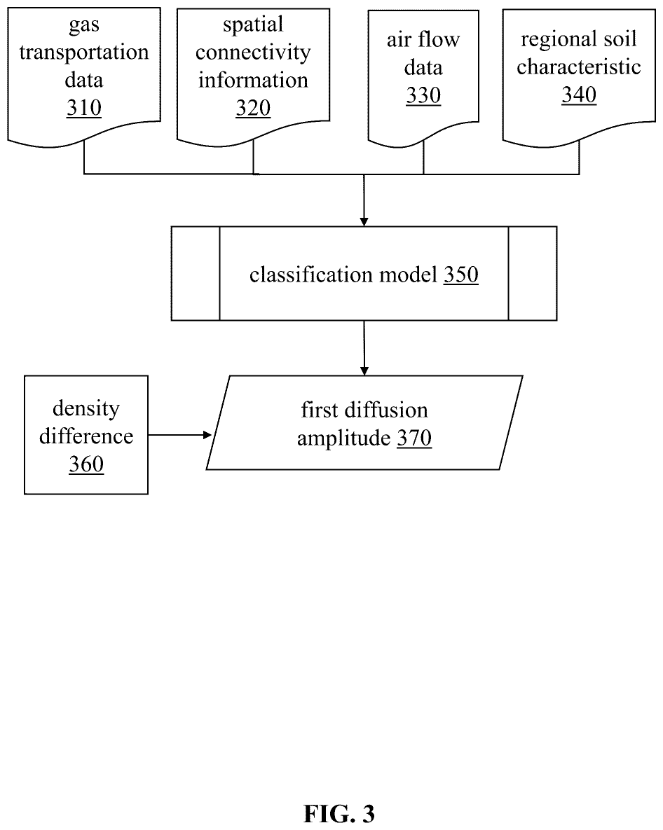

In some embodiments, the estimated diffusion amplitude includes a first diffusion amplitude corresponding to a diffusion stage, and the emergency supervision management platform may determine the first diffusion amplitude via a classification model. More details about this part may be found in FIG. 3 and related descriptions.

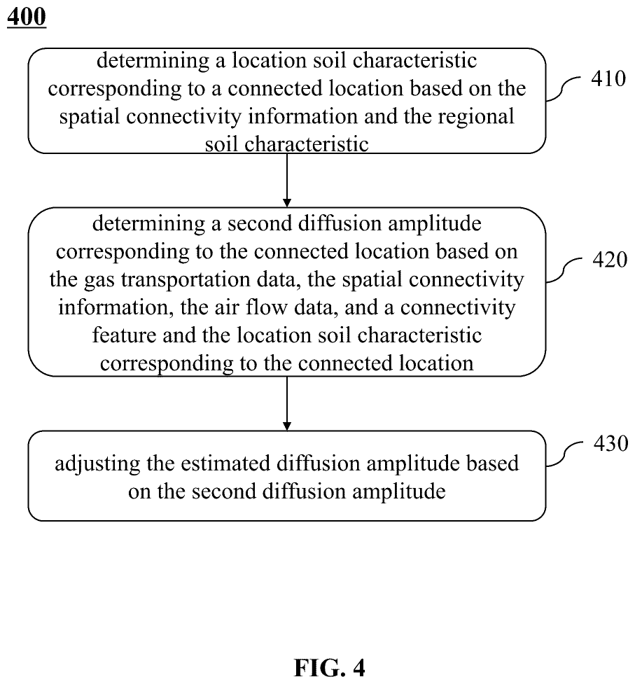

In some embodiments, the emergency supervision management platform may determine a second diffusion amplitude corresponding to a connected location based on the gas transportation data, spatial connectivity information, air flow data, a connectivity feature corresponding to the connected location, and a location soil characteristic. More details may be found in FIG. 4 and related descriptions.

In 240, determining an inspection frequency and a sampling frequency based on the estimated diffusion amplitude, and sending the inspection frequency and the sampling frequency to the emergency supervision object platform, to control the inspection robot to perform inspection based on the inspection frequency and obtain a soil sample based on the sampling frequency during inspection.

The inspection frequency refers to a count of inspections performed by the inspection robot per unit time. For example, the inspection frequency may be 10 times per hour. The sampling frequency refers to a count of soil samples taken by the inspection robot during a single inspection.

In some embodiments, the emergency supervision management platform may determine the inspection frequency and the sampling frequency by querying a second preset table based on the estimated diffusion amplitude.

The second preset table includes the correspondence between the estimated diffusion amplitude and the inspection frequency and sampling frequency. The second preset table may be constructed by humans based on historical experience or historical data.

In 250, receiving a leakage warning sent by the inspection robot when the soil sample is in an abnormal state.

In some embodiments, in response to the concentration of the target gas in soil samples from N consecutive points being greater than the first concentration threshold, the inspection robot determines that the soil sample is in an abnormal state, generates a leakage warning, and sends it to the emergency supervision management platform. The N consecutive points may be N points where the inspection robot consecutively performs soil sampling. The value of N and the first concentration threshold may be set by humans based on historical experience.

The leakage warning is used to alert the user that gas leakage may occur in the target pipeline. The leakage warning includes a gas leakage point and the concentration of the target gas in the corresponding soil sample, etc. The gas leakage point refers to a location on the pipeline where gas leakage occurs. In some embodiments, there are a plurality of pipeline preset points on the target pipeline, which may be pre-calibrated by humans. The emergency supervision management platform may determine a point with a highest target gas concentration among the N consecutive points where the soil sample is in the abnormal state, and determine a pipeline preset point closest to the point as the gas leakage point.

In some embodiments of the present disclosure, by controlling the inspection frequency and the sampling frequency of the inspection robot based on the estimated diffusion amplitude, it can dynamically adjust the working parameters of the inspection robot in real-time according to the actual situation of gas diffusion around the pipeline, to achieve precise discrimination and timely warning of leakage risks, realize effective emergency supervision, and reduce the hazards of gas leakage.

FIG. 3 is a schematic diagram illustrating an exemplary process for determining a first diffusion amplitude according to some embodiments of the present disclosure.

In some embodiments, the estimated diffusion amplitude includes a first diffusion amplitude corresponding to a diffusion stage.

More details about the estimated diffusion amplitude may be found in FIG. 2 and related descriptions.

The diffusion stage refers to a stage of the target gas diffusing in the soil. For example, the emergency supervision management platform may take the gas leakage point as the center and divide it into a plurality of concentric circles with a plurality of different preset distances as radii. A plurality of rings from the inside to the outside are a plurality of diffusion ranges in sequence. A process of the target gas diffusing into a diffusion range until it fills that diffusion range is recorded as the diffusion stage corresponding to that diffusion range, i.e., one diffusion range corresponds to one diffusion stage, and each diffusion stage has its corresponding diffusion speed and diffusion volume.

The first diffusion amplitude refers to the diffusion amplitude corresponding to the target gas in a diffusion stage. A diffusion period, the diffusion range, the diffusion speed, and the diffusion volume corresponding to each diffusion stage constitute the first diffusion amplitude corresponding to that diffusion stage. The estimated diffusion amplitude includes the first diffusion amplitudes corresponding to a plurality of diffusion stages.

The diffusion period corresponding to a diffusion stage refers to a time period when the target gas diffuses into the diffusion range corresponding to that diffusion stage until the target gas fills that diffusion range.

In some embodiments, as shown in FIG. 3, the emergency supervision management platform may determine the first diffusion amplitude 370 corresponding to the diffusion stage via a classification model 350 based on gas transportation data 310, spatial connectivity information 320, air flow data 330, and a regional soil characteristic 340; and adjust the first diffusion amplitude 370 based on a density difference 360 between the target gas and air.

The classification model is a model used to determine the first diffusion amplitude. In some embodiments, the classification model is a machine learning model, such as a Deep Neural Networks (DNN) model, etc.

An input of the classification model includes the gas transportation data, the spatial connectivity information, the air flow data, and the regional soil characteristic. An output of the classification model includes the first diffusion amplitude corresponding to the diffusion stage.

More details about the gas transportation data, the spatial connectivity information, the air flow data, and the regional soil characteristic may be found in FIG. 2 and related descriptions.

In some embodiments, the emergency supervision management platform may train the classification model based on a plurality of first training samples with first labels. The emergency supervision management platform may input the first training samples into an initial classification model, construct a loss function based on the first labels and the output of the initial classification model, iteratively update parameters of the initial classification model based on the loss function, and end the iteration when an iteration end condition is met, and obtaining a trained classification model. An iterative update manner includes but are not limited to gradient descent, and the iteration end condition may be that the loss function converges, or a count of iterations reaches a threshold.

The first training samples may be obtained based on historical data. The first training samples include historical gas transportation data, historical spatial connectivity information, historical air flow data, and historical regional soil characteristics corresponding to historical target pipelines.

The first label includes reference first diffusion amplitudes corresponding to a plurality of reference diffusion stages of the historical target pipeline.

A historical target pipeline corresponding to a first training sample has a plurality of historical leakage processes, and each historical leakage process has a corresponding historical gas leakage point.

For each historical gas leakage point, the emergency supervision management platform may construct a plurality of clustering vectors based on the historical diffusion range, the historical diffusion period, the historical diffusion speed, and the historical diffusion volume corresponding to that historical gas leakage point in the plurality of historical leakage processes, one clustering vector being composed of the historical diffusion range, the historical diffusion period, the historical diffusion speed, and the historical diffusion volume corresponding to one historical leakage process; and cluster the plurality of clustering vectors based on the historical diffusion speed and the historical diffusion volume to obtain a plurality of clustering clusters.

For each clustering cluster, an average of the historical diffusion ranges corresponding to the plurality of clustering vectors in that cluster is determined as a reference diffusion range, i.e., determining a reference diffusion stage. A union of the historical diffusion periods corresponding to the plurality of clustering vectors in that cluster is determined as the reference diffusion period corresponding to that reference diffusion stage. A mean of the historical diffusion speeds and a mean of the historical diffusion volumes corresponding to the plurality of clustering vectors in that cluster are determined as the reference diffusion speed and reference diffusion volume corresponding to that reference diffusion stage, respectively.

The plurality of reference diffusion stages and their corresponding a plurality of reference diffusion ranges, a plurality of reference diffusion speeds, and a plurality of reference diffusion volumes are obtained from the plurality of clustering clusters. Thus, a plurality of reference first diffusion amplitudes corresponding to the plurality of reference diffusion stages may be constructed as the first label.

A clustering manner includes but is not limited to K-Means clustering algorithm, DBSCAN clustering algorithm, etc.

In some embodiments, the emergency supervision management platform may directly obtain a density of the target gas and a density of air pre-uploaded by humans and determine an absolute value of a difference between the two as the density difference between the target gas and air.

In some embodiments, the emergency supervision management platform may determine a diffusion speed influence value and a diffusion volume influence value by querying a third preset table based on the density difference between the target gas and air.

The third preset table includes the correspondence between the density difference between the target gas and air, and the diffusion speed influence value and the diffusion volume influence value. The greater the density difference between the target gas and air, the greater the diffusion speed influence value and the greater the diffusion volume influence value. The third preset table may be constructed by humans based on historical experience.

The diffusion speed influence value and the diffusion volume influence value respectively reflect a degree to which the density difference between the target gas and air affects the diffusion speed and diffusion volume of the target gas.

In some embodiments, the emergency supervision management platform may determine a product of the diffusion speed and the diffusion speed influence value as an adjusted diffusion speed and determine a product of the diffusion volume and the diffusion volume influence value as the adjusted diffusion volume, thereby obtaining an adjusted first diffusion amplitude.

The density difference between the target gas and air significantly affects the permeation resistance of the target gas in the soil, thereby influencing its diffusion speed and diffusion volume. In some embodiments of the present disclosure, by adjusting the first diffusion amplitude based on the density difference between the target gas and air, it can improve the reliability of predicting the diffusion amplitude.

FIG. 4 is a flowchart illustrating an exemplary process for determining an estimated diffusion amplitude according to some embodiments of the present disclosure. As shown in FIG. 4, a process 400 includes the following operations. In some embodiments, the process 400 may be executed by the emergency supervision management platform 130.

In 410, determining a location soil characteristic corresponding to a connected location based on the spatial connectivity information and the regional soil characteristic.

More details about the estimated diffusion amplitude, the spatial connectivity information, and the regional soil characteristic may be found in FIG. 2 and related descriptions.

The location soil characteristic refers to a soil characteristic corresponding to the connected location. In some embodiments, the emergency supervision management platform may determine the soil characteristic of a point closest to the connected location as the location soil characteristic corresponding to the connected location.

In some embodiments, the emergency supervision management platform may determine a preset quantity of adjacent points for the connected location, and location soil characteristics corresponding to the adjacent points based on the spatial connectivity information and the regional soil characteristic; and determine the location soil characteristic corresponding to the connected location based on the location soil characteristics corresponding to the adjacent points.

In some embodiments, the preset quantity is related to the regional soil characteristic corresponding to the target pipeline in a previous preset period. The larger a standard deviation or a variance of the soil characteristics of the plurality of points in the target region, the more complex a distribution of soil composition and a distribution of type in the target region, and thus the larger the preset quantity, to improve the reliability of the location soil characteristic.

In some embodiments, the emergency supervision management platform may determine a preset quantity of points closest to the connected location as the adjacent points and determine an average value of the soil characteristics corresponding to the preset quantity of adjacent points as the location soil characteristic corresponding to the connected location.

In some embodiments of the present disclosure, by determining the location soil characteristic corresponding to the connected location based on the soil characteristics of a plurality of points near the connected location, it can obtain a more accurate location soil characteristic.

In 420, determining a second diffusion amplitude corresponding to the connected location based on the gas transportation data, the spatial connectivity information, the air flow data, a connectivity feature and the location soil characteristic corresponding to the connected location.

The connectivity feature refers to a characteristic related to a connectivity situation at the connected location. For example, the connectivity feature includes whether there is an opening at the connection, whether it is in direct contact with soil, etc. The connectivity feature corresponding to the connected location may also be determined based on the underground pipeline as-built drawings.

The second diffusion amplitude refers to a diffusion amplitude of the target gas at the connected location. For example, the second diffusion amplitude includes the estimated diffusion range, the estimated diffusion speed, the estimated diffusion volume, etc., of the target gas at the connected location.

In some embodiments, the emergency supervision management platform may determine the second diffusion amplitude by querying a fourth preset table based on the gas transportation data, the spatial connectivity information, the air flow data, and the connectivity feature and the location soil characteristic corresponding to the connected location.

The fourth preset table includes the correspondence between the gas transportation data, the spatial connectivity information, the air flow data, the connectivity feature corresponding to the connected location, the location soil characteristic, and the second diffusion amplitude. The fourth preset table may be constructed by humans based on historical data. For example, the fourth preset table is constructed using historical gas transportation data, historical spatial connectivity information, historical air flow data, historical connectivity features and historical location soil characteristics corresponding to historical connected locations, recorded during the plurality of historical monitoring, along with their corresponding historical actual second diffusion amplitudes.

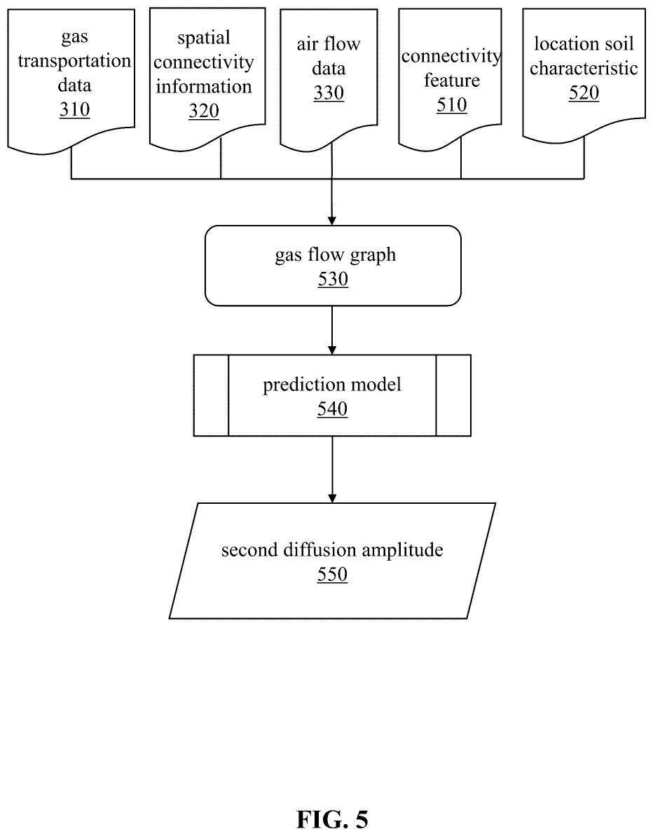

In some embodiments, the emergency supervision management platform may construct a gas flow graph based on the gas transportation data, the spatial connectivity information, the air flow data, and the connectivity feature and the location soil characteristic corresponding to the connected location; and determine, via a prediction model, the second diffusion amplitude corresponding to the connected location based on the gas flow graph. More details may be found in FIG. 5 and related descriptions.

In 430, adjusting the estimated diffusion amplitude based on the second diffusion amplitude.

In some embodiments, the emergency supervision management platform may determine an overlapping part between the estimated diffusion range corresponding to the estimated diffusion amplitude determined by querying the first preset table and the estimated diffusion range corresponding to the second diffusion amplitude as the adjusted diffusion range; perform a weighted summation on the estimated diffusion speed corresponding to the estimated diffusion amplitude determined by querying the first preset table and the estimated diffusion speed corresponding to the second diffusion amplitude, and determine a weighted sum result as the adjusted diffusion amplitude. A weight of the estimated diffusion speed corresponding to the estimated diffusion amplitude is much greater than a weight of the estimated diffusion speed corresponding to the second diffusion amplitude. The adjustment method for the diffusion volume is similar, and is not repeated here, thus obtaining the adjusted estimated diffusion amplitude.

In some embodiments of the present disclosure, by adjusting the estimated diffusion amplitude based on the diffusion amplitude of the target gas corresponding to the connected location, it can improve the accuracy of the estimated diffusion amplitude.

FIG. 5 is a schematic diagram illustrating an exemplary process for determining a second diffusion amplitude according to some embodiments of the present disclosure.

In some embodiments, as shown in FIG. 5, the emergency supervision management platform may construct a gas flow graph 530 based on the gas transportation data 310, the spatial connectivity information 320, the air flow data 330, and a connectivity feature 510 and a location soil characteristic 520 corresponding to the connected location; and determine, via a prediction model 540, a second diffusion amplitude 550 corresponding to the connected location based on the gas flow graph 530.

The gas flow graph refers to a graph describing a flow path and characteristics of the target gas, consisting of nodes and directed edges.

In some embodiments, the nodes of the gas flow graph include the connected locations and gas leakage points.

A node feature corresponding to the connected location may include the connectivity feature and a location soil characteristic of the connected location.

A node feature corresponding to the gas leakage point may include gas transportation data.

More details about the gas transportation data, the connected location, the connectivity feature, and the location soil characteristic may be found in the related descriptions of FIG. 2 and FIG. 4.

In some embodiments, for any node in the gas flow graph, the node feature of that node further includes a standard deviation of the location soil characteristics of a plurality of points within a preset range corresponding to the node.

In some embodiments, the preset range corresponding to the node may refer to a region within a preset distance from the node. The preset distance may be preset by humans. The preset range may be smaller than the first preset range in FIG. 2.

In some embodiments of the present disclosure, using the standard deviation of the location soil characteristics of the plurality of points within the preset range corresponding to a node as a node feature can more accurately reflect the local complexity of soil composition and soil structure near the node, thereby improving the accuracy of subsequently determining the diffusion speed of the target gas through the prediction model, and providing more reliable data support for emergency supervision decisions.

In some embodiments, the directed edges of the gas flow graph include underground utility tunnels, pipe trenches, manholes, etc., between the nodes, with a direction of the edge being a direction of gas flow.

The edge feature includes air flow data from the target sensors within the underground utility tunnels, the pipe trenches, the manholes, etc., corresponding to the edge. More details about the air flow data may be found in the related description of FIG. 2.

The prediction model is a model used to predict the second diffusion amplitude. In some embodiments, the prediction model may be a machine learning model, such as a Graph Neural Networks (GNN) model, etc. In some embodiments, an input of the prediction model may include the gas flow graph, and an output may include the second diffusion amplitude corresponding to the connected location.

In some embodiments, the prediction model may be trained based on a large count of second training samples with second labels. The second training samples may be obtained based on historical data, the second training samples may include historical gas flow graphs corresponding to historical target pipelines, and the second label may be the historical actual second diffusion amplitude corresponding to each historical connected location.

In some embodiments, a historical target pipeline corresponding to one second training sample has a plurality of historical leakage processes, each of which has a corresponding historical gas flow graph. For each historical connected location, a mean of the historical actual second diffusion amplitudes of that historical connected location in a plurality of historical gas flow graphs is calculated and determined as the historical actual second diffusion amplitude of that historical connected location, thus obtaining the second label. The historical actual second diffusion amplitude is obtained from historical inspection record data and manually labeled as the second label. The training process of the prediction model may refer to a training process of the classification model in FIG. 3 and not repeated here.

In some embodiments of the present disclosure, by constructing the gas flow graph and determining the second diffusion amplitude corresponding to the connected location based on the prediction model, and by integrating multi-dimensional dynamic data such as the gas transportation data, the connectivity feature, and the soil characteristic, the risk of target gas diffusion can be assessed more accurately. It can also adapt to different pipeline network topologies and leakage scenarios, thereby optimizing inspection and emergency management, and improving the safety of urban lifeline engineering.

In some embodiments, in response to a gas leakage occurring in the target pipeline, the emergency supervision management platform may determine a target point where a gas concentration in soil is greater than a preset concentration threshold based on inspection data from the inspection robot, and/or determine a target connected location where a diffusion volume is greater than a preset diffusion threshold based on a second diffusion amplitude corresponding to a connected location, and determine the target point and/or the target connected location as a placement point for a positioning component; generate a suction power and a suction time period for a negative pressure suction device based on the air flow data; and send the placement point, the suction power, and the suction time period to the emergency supervision object platform, to control the inspection robot to place the positioning component at the placement point, and to control the negative pressure suction device to perform suction and/or inhalation based on the suction power and the suction time period.

In some embodiments, after receiving the leakage warning sent by the inspection robot, the emergency supervision management platform may determine whether the pressure of the target pipeline is less than a pressure threshold. If the pressure of the target pipeline is less than the pressure threshold, it is determined that a gas leakage occurs in the target pipeline. The pressure threshold may be preset by humans based on prior experience or set by system default. The pressure of the target pipeline may be detected by pressure sensors deployed inside the pipeline and uploaded to the emergency supervision management platform.

The inspection data refers to data obtained by the inspection robot during the inspection process. For example, inspection data may include the concentration of the target gas in soil samples at various points. In some embodiments, the inspection data may be uploaded by the inspection robot to the emergency supervision management platform.

The target point refers to a point that requires key monitoring and/or handling during the inspection process. In some embodiments, the emergency supervision management platform may determine a point where the concentration of the target gas in the soil sample is greater than the preset concentration threshold as the target point.

The target connected location refers to a connected location that requires key monitoring and/or handling. In some embodiments, the emergency supervision management platform may determine a connected location where the diffusion volume is greater than the preset diffusion threshold as the target connected location based on the first diffusion amplitude corresponding to the connected location.

In some embodiments, both the preset concentration threshold and the preset diffusion threshold may be preset by humans based on experience. The preset concentration threshold may be greater than the first concentration threshold.

In some embodiments, the preset concentration threshold and the preset diffusion threshold are related to a population density and/or a building density.

The population density refers to a count of permanent residents or real-time monitored people per unit area. The building density refers to a count of buildings per unit area or a proportion of building floor area. In some embodiments, the inspection robot may also be equipped with an image acquisition device (e.g., camera, etc.) to capture images and upload them to the emergency supervision management platform. The emergency supervision management platform may perform image recognition on the images to obtain population density and building density. Image recognition manners may be computer vision manners, deep learning models, etc.

In some embodiments, the preset concentration threshold and the preset diffusion threshold may be negatively correlated with the population density and/or the building density. For example, the greater the population density and/or the building density, the greater the risk of gas poisoning, thus the smaller the preset concentration threshold and the preset diffusion threshold need to be.

In some embodiments of the present disclosure, by determining the preset concentration threshold and the preset diffusion threshold based on population density and/or building density, dynamic risk grading management can be achieved, thereby optimizing emergency resource allocation while ensuring public safety.

The positioning component refers to a component used to mark a region with gas leakage risk, such as a warning light, a warning sign, etc.

The placement point refers to a point where the positioning component is placed.

In some embodiments, the emergency supervision management platform may directly determine the target point and/or the target connected location as the placement point for the positioning component.

The negative pressure suction device refers to a device that extracts and collects gases and/or particles by generating negative pressure, such as a negative pressure suction machine, etc. The negative pressure suction device may be deployed near the exits in the pipe trenches, the underground utility tunnels, and the manholes.

In some embodiments, based on the spatial connectivity information and air flow data, the emergency supervision management platform may determine whether the target gas is flowing towards a region where the population density is greater than a population threshold, and/or the building density is greater than a building threshold. If so, it activates a plurality of negative pressure suction devices deployed at the locations where the target gas flows through in the underground utility tunnels, the pipe trenches, and the manholes. It controls the negative pressure suction devices to perform suction and/or inhalation based on the suction power and the suction time period, to change the air flow direction and air flow rate within the underground space, ensuring the flow direction of the target gas being altered, thereby guaranteeing the safety of population and/or building aggregation regions. The population threshold and the building threshold may be preset based on prior experience.

The suction power refers to a power of the negative pressure suction device during operation. The suction time period refers to an operating period of the negative pressure suction device.

In some embodiments, the suction power is dynamically adjusted. The emergency supervision management platform may control the negative pressure suction device to increase power starting from a standard suction power until the air flow direction changes. The power of the negative pressure suction device at that time is determined as the stable suction power. The negative pressure suction device continues to suction at the stable suction power during the suction time period. The standard suction power may be preset based on prior experience.

In some embodiments, the emergency supervision management platform may determine the time when the target gas flows through each location based on the air flow rate. For each location, it pre-activates the corresponding negative pressure suction device within a preset period before the corresponding time, until the air flow direction at that location changes and stabilizes. At this time, the corresponding negative pressure suction device is turned off. The period from when the negative pressure suction device is turned on until it is turned off is the suction time period. The duration of the preset period may be preset by humans based on experience.

In some embodiments, the emergency supervision management platform may generate a display frequency and a display color corresponding to the placement point based on a first diffusion amplitude corresponding to a diffusion stage, and send them to the emergency supervision object platform, to control the positioning component to flash based on the display frequency and emit light based on the display color.

More details about the diffusion stage and the first diffusion amplitude may be found in FIG. 3 and related descriptions.

In some embodiments, the emergency supervision management platform may obtain the diffusion stage to which the positioning component belongs based on the diffusion range to which the placement point of the positioning component belongs and determine the display frequency and display color of the positioning component by querying a fifth preset table. The fifth preset table includes the diffusion stage, the display frequency, and the display color. The earlier the diffusion stage, i.e., the closer the diffusion range is to the gas leakage point, the higher the display frequency may be and the more conspicuous the display color may be.

In some embodiments of the present disclosure, dynamically generating the display frequency and display color of the positioning component based on the first diffusion amplitude of the diffusion stage can dynamically respond to diffusion changes and achieve visualized graded risk warning.

In some embodiments of the present disclosure, by determining the placement point of the positioning component and the suction power and suction time period of the negative pressure suction device, precise localization of gas leakage risks, dynamic graded response, and automated emergency handling can be achieved. This enables rapid suppression of gas diffusion, optimization of resource allocation, and reduction of personnel casualties and environmental pollution risks.

Certain features, structures, or characteristics in one or more embodiments of the present disclosure may be appropriately combined.

Furthermore, unless explicitly stated in the claims, the order of processing elements and sequences, the use of numerical and alphabetic characters, or the use of other names in the present disclosure are not intended to limit the sequence of the processes and methods described herein. While various examples have been discussed in the present disclosure to illustrate certain inventive embodiments that are currently considered useful, it should be understood that such details are provided for illustrative purposes and that the appended claims are not limited to the disclosed embodiments. Instead, the claims are intended to cover all modifications and equivalent combinations that fall within the spirit and scope of the embodiments described in the present disclosure. For example, while the system components described above may be implemented through hardware devices, they may also be achieved solely through software solutions, such as by installing the described system on existing servers or mobile devices.

If there is any inconsistency or conflict between the descriptions, definitions, and/or use of terms in the materials cited in the present disclosure and the content described in the present disclosure, the descriptions, definitions, and/or use of terms in the present disclosure shall prevail.

What is claimed is:

1. An Internet of Things (IoT) large model system for lifeline engineering emergency supervision in smart cities, comprising: an emergency supervision user platform, an emergency supervision service platform, an emergency supervision management platform, an emergency supervision sensor network platform, and an emergency supervision object platform; wherein
the emergency supervision management platform is configured to:
in response to a gas environmental characteristic corresponding to a target pipeline satisfying a warning condition, every preset period:
determine a target sensor based on spatial connectivity information corresponding to the target pipeline, and obtain air flow data corresponding to the target sensor;
obtain a regional soil characteristic corresponding to the target pipeline;
determine an estimated diffusion amplitude of a target gas based on gas transportation data of the target pipeline, the spatial connectivity information, the air flow data, and the regional soil characteristic; and
determine an inspection frequency and a sampling frequency based on the estimated diffusion amplitude, and send the inspection frequency and the sampling frequency to the emergency supervision object platform; wherein an inspection robot within the emergency supervision object platform is configured to perform inspection based on the inspection frequency, obtain a soil sample based on the sampling frequency during inspection, and send a leakage warning to the emergency supervision management platform when the soil sample is in an abnormal state.

2. The IoT large model system of claim 1, wherein the estimated diffusion amplitude includes a first diffusion amplitude corresponding to a diffusion stage, and the emergency supervision management platform is further configured to:
determine, via a classification model, the first diffusion amplitude corresponding to the diffusion stage based on the gas transportation data, the spatial connectivity information, the air flow data, and the regional soil characteristic, wherein the classification model is a machine learning model; and
adjust the first diffusion amplitude based on a density difference between the target gas and air.

3. The IoT large model system of claim 1, wherein the emergency supervision management platform is further configured to:
determine a location soil characteristic corresponding to a connected location based on the spatial connectivity information and the regional soil characteristic;
determine a second diffusion amplitude corresponding to the connected location based on the gas transportation data, the spatial connectivity information, the air flow data, and a connectivity feature and the location soil characteristic corresponding to the connected location; and
adjust the estimated diffusion amplitude based on the second diffusion amplitude.

4. The IoT large model system of claim 3, wherein the emergency supervision management platform is further configured to:
determine a preset quantity of adjacent points for the connected location, and location soil characteristics corresponding to the adjacent points based on the spatial connectivity information and the regional soil characteristic; wherein the preset quantity is related to the regional soil characteristic corresponding to the target pipeline in a previous preset period; and
determine the location soil characteristic corresponding to the connected location based on the location soil characteristics corresponding to the adjacent points.

5. The IoT large model system of claim 3, wherein the emergency supervision management platform is further configured to:
construct a gas flow graph based on the gas transportation data, the spatial connectivity information, the air flow data, and the connectivity feature and the location soil characteristic corresponding to the connected location; and
determine, via a prediction model, the second diffusion amplitude corresponding to the connected location based on the gas flow graph, wherein the prediction model is a machine learning model.

6. The IoT large model system of claim 5, wherein a node feature of the gas flow graph includes a standard deviation of the location soil characteristics of a plurality of points within a preset range corresponding to a node.

7. The IoT large model system of claim 1, wherein the emergency supervision management platform is further configured to:
in response to a gas leakage occurring in the target pipeline,
determine a target point where a gas concentration in soil is greater than a preset concentration threshold based on inspection data from the inspection robot, and/or determine a target connected location where a diffusion volume is greater than a preset diffusion threshold based on a second diffusion amplitude corresponding to a connected location, and determine the target point and/or the target connected location as a placement point for a positioning component;
generate a suction power and a suction time period for a negative pressure suction device based on the air flow data; and
send the placement point, the suction power, and the suction time period to the emergency supervision object platform, to control the inspection robot to place the positioning component at the placement point, and to control the negative pressure suction device to perform suction and/or inhalation based on the suction power and the suction time period.

8. The IoT large model system of claim 7, wherein the emergency supervision management platform is further configured to:
generate a display frequency and a display color corresponding to the placement point based on a first diffusion amplitude corresponding to a diffusion stage and send the display frequency and the display color to the emergency supervision object platform, to control the positioning component to flash based on the display frequency and emit light based on the display color.

9. The IoT large model system of claim 7, wherein the preset concentration threshold and the preset diffusion threshold are related to a population density and/or a building density.

10. A method for lifeline engineering emergency supervision in smart cities, implemented by an emergency supervision management platform of an Internet of Things (IoT) large model system for lifeline engineering emergency supervision in smart cities, the method comprising:
in response to a gas environmental characteristic corresponding to a target pipeline satisfying a warning condition, every preset period:
determining a target sensor based on spatial connectivity information corresponding to the target pipeline, and obtaining air flow data corresponding to the target sensor;
obtaining a regional soil characteristic corresponding to the target pipeline;
determining an estimated diffusion amplitude of a target gas based on gas transportation data of the target pipeline, the spatial connectivity information, the air flow data, and the regional soil characteristic;
determining an inspection frequency and a sampling frequency based on the estimated diffusion amplitude, and sending the inspection frequency and the sampling frequency to an emergency supervision object platform, to control an inspection robot to perform inspection based on the inspection frequency and obtain a soil sample based on the sampling frequency during inspection; and
receiving a leakage warning sent by the inspection robot when the soil sample is in an abnormal state.

11. The method of claim 10, wherein the estimated diffusion amplitude includes a first diffusion amplitude corresponding to a diffusion stage, and the determining an estimated diffusion amplitude of a target gas based on gas transportation data of the target pipeline, the spatial connectivity information, the air flow data, and the regional soil characteristic comprises:
determining, via a classification model, the first diffusion amplitude corresponding to the diffusion stage based on the gas transportation data, the spatial connectivity information, the air flow data, and the regional soil characteristic, wherein the classification model is a machine learning model; and
adjusting the first diffusion amplitude based on a density difference between the target gas and air.

12. The method of claim 10, wherein the determining an estimated diffusion amplitude of a target gas based on gas transportation data of the target pipeline, the spatial connectivity information, the air flow data, and the regional soil characteristic further comprises:
determining a location soil characteristic corresponding to a connected location based on the spatial connectivity information and the regional soil characteristic;
determining a second diffusion amplitude corresponding to the connected location based on the gas transportation data, the spatial connectivity information, the air flow data, and a connectivity feature and the location soil characteristic corresponding to the connected location; and
adjusting the estimated diffusion amplitude based on the second diffusion amplitude.

13. The method of claim 12, wherein the determining a location soil characteristic corresponding to a connected location based on the spatial connectivity information and the regional soil characteristic comprises:
determining a preset quantity of adjacent points for the connected location, and location soil characteristics corresponding to the adjacent points based on the spatial connectivity information and the regional soil characteristic; wherein the preset quantity is related to the regional soil characteristic corresponding to the target pipeline in a previous preset period; and
determining the location soil characteristic corresponding to the connected location based on the location soil characteristics corresponding to the adjacent points.

14. The method of claim 12, wherein the determining a second diffusion amplitude corresponding to the connected location based on the gas transportation data, the spatial connectivity information, the air flow data, and a connectivity feature and the location soil characteristic corresponding to the connected location comprises:
constructing a gas flow graph based on the gas transportation data, the spatial connectivity information, the air flow data, and the connectivity feature and the location soil characteristic corresponding to the connected location; and
determining, via a prediction model, the second diffusion amplitude corresponding to the connected location based on the gas flow graph, wherein the prediction model is a machine learning model.

15. The method of claim 14, wherein a node feature of the gas flow graph includes a standard deviation of the location soil characteristics of a plurality of points within a preset range corresponding to a node.

16. The method of claim 10, wherein the method further comprises:
in response to a gas leakage occurring in the target pipeline,
determining a target point where a gas concentration in soil is greater than a preset concentration threshold based on inspection data from the inspection robot, and/or determining a target connected location where a diffusion volume is greater than a preset diffusion threshold based on a second diffusion amplitude corresponding to a connected location, and determining the target point and/or the target connected location as a placement point for a positioning component;
generating a suction power and a suction time period for a negative pressure suction device based on the air flow data; and
sending the placement point, the suction power, and the suction time period to the emergency supervision object platform, to control the inspection robot to place the positioning component at the placement point, and to control the negative pressure suction device to perform suction and/or inhalation based on the suction power and the suction time period.

17. The method of claim 16, wherein the method further comprises:
generating a display frequency and a display color corresponding to the placement point based on a first diffusion amplitude corresponding to a diffusion stage and sending the display frequency and the display color to the emergency supervision object platform, to control the positioning component to flash based on the display frequency and emit light based on the display color.

18. The method of claim 16, wherein the preset concentration threshold and the preset diffusion threshold are related to a population density and/or a building density.
